(19) United States
(12) Patent Application Publication
(10) Pub. No.: US 2004/0205655 A1
(43) Pub. Date: Oct. 14, 2004

(54) Method and system for producing a book from a video source

(76) Inventor: Watson Wu, Hsinchu (TW)

Correspondence Address: BIRCH STEWART KOLASCH & BIRCH, PO BOX 747, FALLS CHURCH, VA, 22040-0747, US

(21) Appl. No.: 10/034,390

(22) Filed: Jan. 3, 2002

(30) Foreign Application Priority Data
Sep. 13, 2001 (TW) 90122705

(51) Int. Cl. G06F 17/24

(52) U.S. Cl. 715/530; 715/500.1

(57) ABSTRACT

A book producing system for producing a book, which includes a text part and an illustration part. The book producing system includes a video-receiving module, a decoding module, a text-extracting module, an illustration-extracting module and a book-producing module. In this invention, the video-receiving module receives video source data; the decoding module decodes the video source data into video data; the text-extracting module extracts the text part from the video data according to a production guide; the illustration-extracting module extracts at least one key frame, serving as the illustration part, from the video data according to the production guide; the book-producing module typesets the extracted text part and illustration part to produce the book. The invention also discloses a book producing method for implementing the above-mentioned book producing system.

### BACKGROUND OF THE INVENTION

1. Field of the Invention

The invention relates to a book producing system and method, in particular to a book producing system and method for producing books in which computer software is used for analyzing video sources and automatically producing book pages.

2. Description of the Related Art

Using current technology, when illustration books, picture books, comic books, e-books, and the like are produced, the source content used for the books is usually from manual drafting or from a lot of individual frames edited and filed by using the computer, so that books are embodied.

However, with the popularization of electronic information products, such as digital video cameras, TV tuner cards, setup boxes, DVDs, VCDs, and the like, users can easily obtain digital videos. Thus, in the multimedia field of computers, processing video sources using the computer in order to produce book documents is an important application.

As described above, when the obtained image data are not individual frames but video sources of continuous frames, the user has to separate video sources of continuous frames into a plurality of frames or images. Then, the images can be edited and filed by using the computer. However, for general video content, using the NTSC standard, 29.97 interlaced frames are broadcasted per second; and using the PAL standard, 25 interlaced frames are broadcasted per second. Thus, a one-minute video includes 1500 to 1800 frames. If the user edits each frame one by one, it will be time-consuming and inefficient.

Therefore, it is an important matter to efficiently produce book documents from the content of videos.

### SUMMARY OF THE INVENTION

In view of the above-mentioned problems, it is therefore an object of the invention to provide a book producing system and method capable of automatically analyzing a video source to produce book documents such as illustration books, picture books, comic books, e-books, and the like.

To achieve the above-mentioned object, the book producing system of the invention is used for producing a book including a text part and an illustration part. The book producing system includes a video-receiving module, a decoding module, a text-extracting module, an illustration-extracting module and a book-producing module. In this invention, the video-receiving module receives video source data. The decoding module decodes the video source data, which may be any video format, into video data. The text-extracting module extracts the text part from the video data according to a production guide. The illustration-extracting module extracts at least one key frame, as the illustration part, from the video data according to the production guide. Then, the book-producing module produces the book according to the extracted text part and illustration part.

In addition, the book producing system of the invention further includes an editing module, a book-template-selecting module, and a production-guide-selecting module. In the invention, the production-guide-selecting module receives a required production guide selected by a user. The editing module receives an edit command from the user to edit the contents of the book. The book-template-selecting module receives at least one book template selected as required by a user. The book-producing module applies the selected book template for typesetting the text part and illustration part so as to produce the book.

As described above, the production guide that can be selected by the production-guide-selecting module includes an audio-analyzing algorithm, a caption-analyzing algorithm, a scene/shot shift-analyzing algorithm and an image-analyzing algorithm. The audio-analyzing algorithm is used for analyzing the audio data of the video data. The caption-analyzing algorithm is used for analyzing the caption data of the video data. The scene/shot shift-analyzing algorithm is used for analyzing the scene/shot shift data of the video data. The image-analyzing algorithm is used for analyzing the image data of the video data, analyzing and comparing the image data with the image sample data that are provided in advance, analyzing and comparing the image data with the object data that are provided in advance, or analyzing the caption image data of the image data.

Consequently, according to the above-mentioned audio-analyzing algorithm, caption-analyzing algorithm, scene/shot shift-analyzing algorithm, or image-analyzing algorithm, the text-extracting module and the illustration-extracting module can extract the data (such as the text part, the illustration part and the like) needed for producing the book. Then, the book-producing module applies the above-mentioned text part and illustration part to the book template to automatically produce book documents such as illustration books, picture books, comic books, e-books, and the like.

The invention also provides a book producing method including a video-receiving step, a decoding step, a text-extracting step, an illustration-extracting step, and a book-producing step. In this invention, the video-receiving step is first performed to receive the video source data. Next, the decoding step is performed to decode the video source data to obtain the video data. Then, the text-extracting step and the illustration-extracting step are performed to extract the text part and illustration part that are needed to produce the book. Finally, the book-producing step is performed to produce the book according to the text part and the illustration part.

In addition, the book producing method of the invention further includes an editing step, a book-template-selecting step, and a production-guide-selecting step. The editing step is performed to edit the contents of the book after the book is produced. The book-template-selecting step is performed to allow the user to select the required book template so that the book template can be applied in the book-producing step to produce the book. The production-guide-selecting step is performed to allow the user to select the required production guide.

The book producing system and method of the invention can automatically analyze a video source and produce book documents (such as illustration books, picture books, comic books, e-books, or other similar formats) by integrating various technologies (such as video content analysis, character recognition, voice recognition, or other similar technologies) in combination with various video formats. Therefore, the video contents can be efficiently utilized for producing book documents.

### BRIEF DESCRIPTION OF THE DRAWINGS

FIG. 1 is a schematic illustration showing the architecture of a book producing system in accordance with a preferred embodiment of the invention.

FIG. 2 is a flow chart showing a book producing method in accordance with the preferred embodiment of the invention.

FIG. 3 is a schematic illustration showing the processes for extracting key frames in the book producing method in accordance with the preferred embodiment of the invention.

### DETAIL DESCRIPTION OF THE INVENTION

The system and method for producing books in accordance with a preferred embodiment of the invention will be described with reference to the accompanying drawings, wherein the same reference numbers denote the same elements.

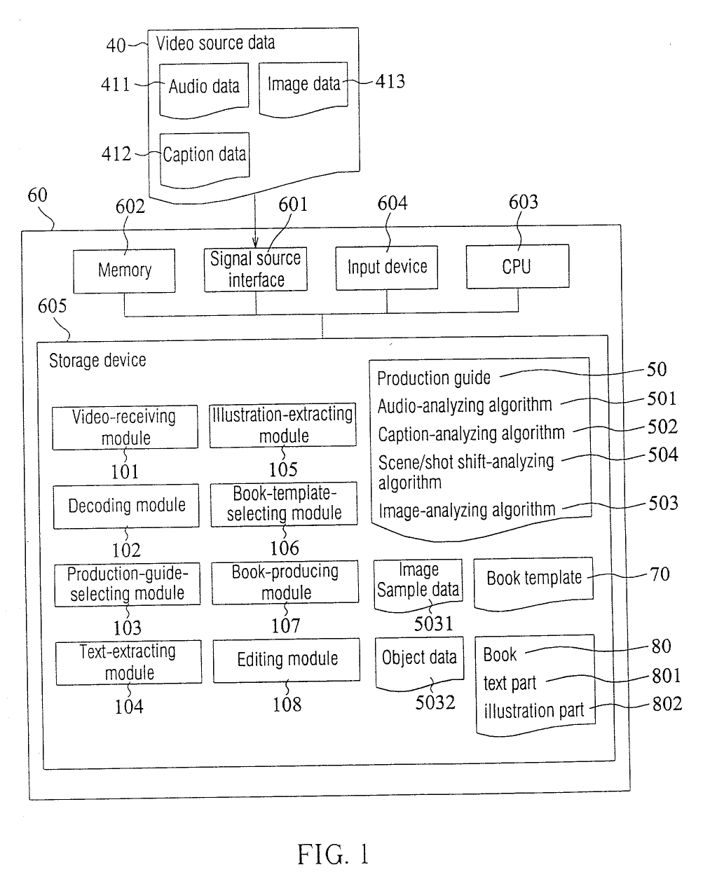

Referring to FIG. 1, a book producing system in accordance with the preferred embodiment of the invention is used to produce a book 80 including a text part 801 and an illustration part 802. The book producing system includes a video-receiving module 101, a decoding module 102, a production-guide-selecting module 103, a text-extracting module 104, an illustration-extracting module 105, a book-template-selecting module 106, a book-producing module 107, and an editing module 108.

In this embodiment, the book producing system can be applied using a computer apparatus 60. The computer apparatus 60 may be a conventional computer device including a signal source interface 601, a memory 602, a central processing unit (CPU) 603, an input device 604, and a storage device 605. The signal source interface 601 is connected to a signal output device. The signal source interface 601 can be any interface device, such as an optical disk player, a FireWire (IEEE 1394 Interface), a universal serial bus (USB). The signal output device is, for example, a digital video camera, TV Tuner, digital video recorder, VCD, DVD, and the like. The memory 602 may be any memory component or a number of memory components, such as DRAMs, SDRAMs, FLASHs or EEPROMs, provided in the computer apparatus 60. The central processing unit 603 adopts any conventional central processing architecture including, for example, an ALU, a register, a controller, and the like. Thus, the CPU 603 is capable of processing and operating with all data and controlling the operations of every element in the computer apparatus 60. The input device 604 may be a device that can be operated by users for inputting information or interacting with software modules, for example, a mouse, keyboard, and the like. The storage device 605 may be any data storage device or a number of data storage devices that can be accessed by using computers, for example, a hard disk, a floppy disk, and the like.

Each of the modules mentioned in this embodiment refers to a software module stored in the storage device 605 or a recording media. Each module is executed by the central processing unit 603, and the functions of each module are implemented by the elements in the computer apparatus 60. However, as is well known to those skilled in the art, it should be noted that each software module can also be manufactured into a piece of hardware, such as an ASIC (application-specific integrated circuit) chip and the like, without departing from the spirit or scope of the invention.

The functions of each module of the embodiment will be described in the following.

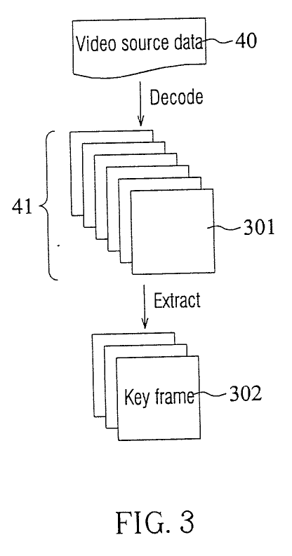

In this embodiment, the video-receiving module 101 receives a video source data 40. The decoding module 102 decodes the video source data 40 to obtain the video data 41. As shown in FIG. 3, the video data 41, including a plurality of individual frames 301 (25 or 29.97 frames per second), are obtained after the video source data 40 are decoded. The production-guide-selecting module 103 receives a command from a user to select a required production guide 50. The text-extracting module 104 extracts the text part 801 from the video data 41 according to the production guide 50. The illustration-extracting module 105 extracts at least one key frame as the illustration part 802 from the video data 41 according to the production guide 50. The book-template-selecting module 106 receives the choice of the user and provides at least one book template 70. The book-producing module 107 applies the book template 70 and produces the book 80 according to the obtained text part 801 and illustration part 802. Finally, after the book 80 is produced, the editing module 108 receives a command from the user to edit the contents of the book 80.

As described above, the video-receiving module 101 operates in combination with the signal source interface 601. For example, the video source data 40 stored in a digital video camera are transferred to the video-receiving module 101 through the FireWire (IEEE 1394 Interface). Alternatively, the video source data 40 recorded in a VCD or DVD are transferred to the video-receiving module 101 through an optical disk player. The video source data 40 may be the video that is stored, transferred, broadcasted, or received by various video-capturing or -receiving devices such as digital video cameras, TV tuner cards, setup boxes, video server and the like, or by various video storage devices such as DVDs and VCDs. Also, the video source data 40 may be stored, transferred, broadcasted, or received in various video data formats, such as MPEG-1, MPEG-2, MPEG-4, AVI, ASF, MOV, and the like.

The decoding module 102 decodes, converts, and decompresses the inputted video source data 40, according to its video format, encoded method, or compressed method, into the data the same as or similar to those before encoded. By doing so, the video data 41 can be generated. For example, if the video source data 40 has been encoded by the lossy compression, only the data similar to those before encoded can be obtained after the decoding process. In this embodiment, the video data 41 includes audio data 411, caption data 412, and image data 413. The audio data 411 includes all the sounds in the video data 41. The caption data 412 are captions presented on the screen in conjunction with the image data 413. The image data 413 are all the individual frames shown in the video data 41. Usually, one second of the video data 41 is composed of 25 individual frames or 29.97 individual frames that are sequentially shown on the screen.

The production-guide-selecting module 103 operates in combination with the input device 604 so that the user can select the guides, which have to be followed for producing the book 80, by way of the input device 604. The production guide 50 provided in this embodiment includes an audio-analyzing algorithm 501, a caption-analyzing algorithm 502, an image-analyzing algorithm 503, and a scene/shot shift-analyzing algorithm 504.

As described above, the audio-analyzing algorithm 501 is used for analyzing the audio data 411 of the video data 41 by way of feature extraction and feature matching methods. The features of the audio data 411 include, for example, the frequency spectrum feature, the volume, the zero crossing rate, the pitch, and other like features. As described above, after the audio features in time domain are extracted, the audio data 411 are passed to the noise reduction and segmentation processes. Then, the Fast Fourier Transform method is used to convert the audio data 411 to the frequency domain. Then, a set of frequency filters is used to extract the feature values, which constitute a frequency spectrum feature vector. The volume is a feature that is easily measured, and a RMS (Root Mean Square) can represent the feature value of the volume. Then, by volume analysis, the segmentation operation can be assisted. That is, using a silence detection, the segment boundaries of the audio data 411 can be determined. The zero crossing rate is used to calculate the number of times that each clip of sound waveform intersects a zero axis. The pitch is a fundamental frequency of the sound waveform. Therefore, in the audio data 411, the feature vector constituted by the above-mentioned audio features and frequency spectrum feature vector thereof can be used for analyzing and comparing the features of the audio templates, so that the required portion of audio data 411 can be obtained. Then, the text part 801 is obtained from the required portion of audio data 411 by using speech recognition technology. Moreover, the image data 413 synchronous and corresponding to the required portion of audio data 411 in the video data 41 are extracted as the illustration part 802.

In this embodiment, the audio-analyzing algorithm 501 is used for providing, in advance, the audio template classes such as the music, speech, animal sound, male speech, female speech, and the like. In this case, the user can select the audio classes that are to be searched. Therefore, the feature matching method is applied for each audio segment in the audio data 411. Within an allowable distant range, the feature matching method searches for the closest audio template class with the closest feature vector, which is apart from the feature vector of the current processing audio segment by the shortest Euclidean distance in feature vector space. If the closest audio template class is the same as the audio class selected by the user, the current processing audio segment satisfies the search condition. In addition, the confidence of each selected audio segment in audio data 411 can be represented by the inverse of the shortest Euclidean distance described above. The corresponding clips of the video frames in the video data 41 are extracted by mapping the selected audio segments in the audio data 411 satisfying the search condition. The images satisfying the extraction requirements are picked out as the illustration part 802 from each shot of the corresponding clips of the video frames.

In addition, if the video data 41 include a caption stream, the caption stream in the corresponding clips of the video frames is read out as the text part 801 of the book 80. If the video data 41 do not include the caption stream, the selected audio segments in the audio data 411 are read out and converted into texts, serving as the text part 801 of the book 80, by a voice-to-text conversion process using speech analysis technology. In addition, the computation complexity of the audio-analyzing algorithm 501 is less than that of the image-analyzing algorithm 503. The data obtained from the audio-analyzing algorithm 501 may also be used as guiding or auxiliary data in the image-analyzing algorithm 503.

The caption-analyzing algorithm 502 is used to analyze the caption data 412 in the video data 41 and screen the video frames having captions. In other words, if the video data 41 include a caption stream, the caption stream is read out as the text part 801, and a first video frame corresponding to, and synchronized with, the captions as the illustration part 802. If the video data 41 do not include the caption stream but the captions are included in the video frames, the character recognition technology is used to extract the captions from the video frames as the text part 801. The video frames that are obtained after the screening are processed to remove the captions by, for example, image processing performed using the data of the previous and next video frames. Thus, the video frames without captions can be obtained as the illustration part 802. As described above, the character recognition technology is performed for character recognition mainly by the optical character recognition (OCR) method.

The image-analyzing algorithm 503 is used to analyze the image data 413 in the video data 41. The analysis is based on the basic visual features such as color, texture, shape, motion, position, and other like features. In this embodiment, when the video frame includes the captions, the character recognition technology is used to extract the captions from the video frame as the text part 801. In addition, the image data 413 in the video data 41 are compared with image sample data 5031, so as to find the frame having image visual features with great similarity or dissimilarity as the illustration part 802. Alternatively, the image data 413 in the video data 41 are compared with the object data 5032. For example, by using the face detection technology, the video frames with a human face in the video data 41 can be found as the illustration part 802. In this embodiment, when a frame, which has image visual features greatly similar to or dissimilar from the image sample data 5031 or the object data 5032, is selected as a key frame candidate of the video data 41, it is possible to screen only one frame in the same shot as the illustration part 802.

The scene/shot shift-analyzing algorithm 504 is used to analyze the scene/shot shifts in the video data 41 and select a first qualified frame after each scene/shot shift in the video data 41. A selected frame after each scene shift is regarded as the first illustration part and an entry point of corresponding paragraph of the book 80. There may be many shot shifts and selected frames between two scene shifts. These sequential frames selected after each shot shift and before next scene shift are in the same paragraph of the book 80. If the video data 41 include a caption stream, the corresponding caption data 412 of each paragraph are read out and serves as the text part 801 of the book 80. If the video data 41 do not include the caption stream, the corresponding audio data 411 of each paragraph are read out. Then, the audio data 411 are converted into texts, serving as the text part 801 of the book 80, by a voice-to-text conversion process using the speech analysis technology.

In general, the video data 41 is a video sequence composed of a number of scenes. Each scene is composed of a plurality of shots. The minimum unit in the film is a shot. The film is composed of a number of shots. In the playbook, the minimum unit is a scene or an act. The scene represents a part in each story or subject. Each scene contains a definite beginning and ending of an event, and such a period of time is called a scene or an act. Usually, a shot is composed of a plurality of frames having uniform visual properties, such as color, texture, shape, and motion. The shots shift with the changes in camera direction and the camera view angle. For instance, different shots are generated when the camera shoots the same scene with different view angles. Alternatively, different shots are generated when the camera shoots different regions with the same view angle.

Since the shots can be distinguished according to some basic visual properties, it is very simple to divide the video data 41 into a plurality of sequential shots using a technology in which statistical data, such as the visual property histogram, of some basic visual properties are analyzed. Therefore, when the visual properties of one frame are different from the visual properties of a previous frame to a certain extent, a split can be made between the frame and the previous frame to produce a shot shift. The shot detection method is widely used in video-editing software. As described above, it is an object of the scene shift analysis to combine a lot of associated shots into a scene. Strictly speaking, the meanings and content of the video data 41 have to be understood. However, the analysis combining the audio properties with the visual properties can also achieve the scene shift analysis to a reasonable extent. Usually, when the scenes shift, the audio properties (such as music, speech, noise, and silence) and the visual properties (such as color and motion) also change. The shots are divided by analyzing only the visual properties. The analysis of audio properties and visual properties both may be used in the scene shift analysis.

The text-extracting module 104 and the illustration-extracting module 105 may be software modules stored in the storage device 605. In accordance with the production guide 50, the text-extracting module 104 and the illustration-extracting module 105 extract the required text part 801 and illustration part 802 as the contents for producing the book 80 through the computations and operations of the central processing unit 603.

The book template 70 provided by the book-template-selecting module 106 may be an illustration book, picture book, e-book, comic book, or other template. The illustration part 802 obtained can be processed by various filters (such as artistic filters, sketch filters and edge filters) so that the users can obtain the desired image processing effects. The book template 70 and various filters are stored in the storage device 605.

The book-producing module 107 is a software module stored in the storage device 605. Through the computations and operations of the central processing unit 603, the book-producing module 107 makes use of the book template 70 to produce a user-desired book. The text part 801 obtained can be processed with fonts and size selected by the user. The illustration part 802 obtained can be processed by using image processing functions, such as resealing, image composing, frame producing, and the like. Thus, the book 80 can be produced according to the book template 70 and user's preference.

Finally, the editing module 108 can be used in combination with the input device 604. Thus, after a sample of the book 80 is produced, the user can further edit the contents of the book 80 through the operation of the input device 604.

For the sake of understanding the content of the invention, the book producing method is disclosed and described in accordance with the preferred embodiment of the invention.

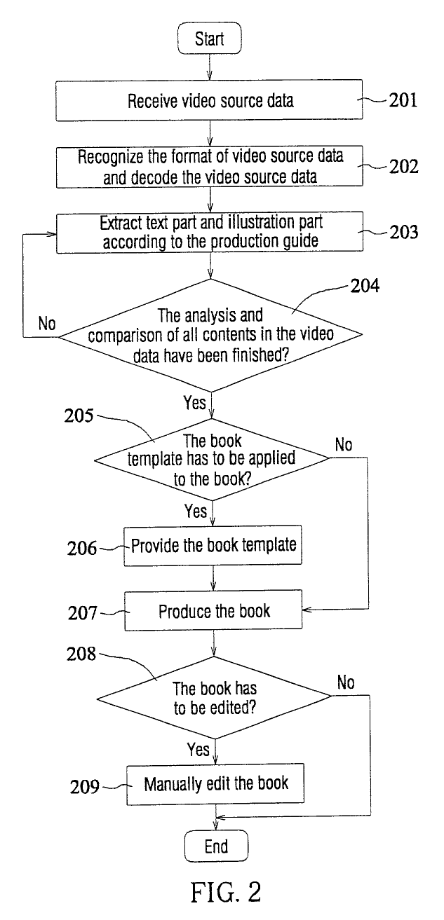

As shown in FIG. 2, in the book producing method 2 according to the preferred embodiment of the invention, the video source data 40 are received in step 201. For example, the video source data 40 recorded in the digital video camera can be transferred to the signal source interface 601 through an IEEE 1394 transmission cable, so that the video source data 40 can be used as the content for producing a book 80.

In step 202, the decoding module 102 recognizes the format of the video source data 40 and decodes the video source data 40 to generate the decoded video data 41. For example, the format of the video source data 40 is an Interlaced MPEG-2 format. That is, it is a frame composed of two fields. Thus, in this step, the MPEG-2 format can be decoded first, and then, the video data 41 can be obtained by deinterlacing with interpolation method and can be displayed by a computer monitor.

In step 203, the text-extracting module 104 and the illustration-extracting module 105 analyze the video data 41 to obtain the text part 801 and the illustration part 802 according to the production guide 50. According to the audio-analyzing algorithm 501, the caption-analyzing algorithm 502, the image-analyzing algorithm 503, and the scene/shot shift-analyzing algorithm 504, the modules 104 and 105 can analyze, search, and screen each video frame and content (including the audio content) of the video data 41 in order to obtain the text part 801 and illustration part 802 satisfying the requirements of the production guide 50. For example, if the video data 41 includes a caption stream, the caption stream of the video data 41 is read out and serves as the text part 801. On the other hand, if the video data 41 does not include the caption stream, the audio of the video data 41 is read out. Then, the text part 801 is obtained from the audio by a voice-to-text conversion process using speech analysis technology. Furthermore, a key frame in the images corresponding to the caption stream or audio is extracted as the illustration part 802. It should be noted that a plurality of key frames might be extracted as the illustration part 802 in this embodiment. As shown in FIG. 3, the video data 41 including a plurality of individual frames 301 (25 or 29.97 frames per second) are obtained after the video source data 40 are decoded. After the analysis and search are made according to the production guide 50, key frames 302 are extracted from the individual frames and serve as the illustration part 802.

Step 204 judges whether or not all the content in the video data 41 have been analyzed and compared. If all the content in the video data 41 have not been analyzed and compared, step 203 is repeated. If all the content in the video data 41 have been analyzed and compared, step 205 is performed.

Step 205 judges whether or not the book template 70 needs to be used in producing the book 80. When the book template 70 needs to be used in producing the book 80, the process goes to step 206. When the book template 70 does not need to be used in producing the book 80, the process goes to step 207.

In step 206, the book-template-selecting module 106 provides the user choices for template 70 and various layouts. The book template 70 includes various book templates having pictures, images, photos, paintings or drawings. The book templates may be, for example, comic books, illustration books, picture books, e-books, and the like.

In step 207, the book-producing module 107 produces the book 80 according to the text part 801 and illustration part 802 obtained in step 203. When step 206 is performed, the book template 70 provided in step 206 is used. Furthermore, the illustration part 802 is processed by way of various filters (such as artistic filters, sketch filters and edge filters) so that the desired image processing effects can be obtained. Again, image-processing functions, such as rescaling, image composing, frame producing, and the like, are utilized to obtain an image frame satisfying the book template 70. Then, the book-producing process using the text part 801 and the illustration part 802 in conjunction with the book template 70 (when step 206 is performed), fonts, and choices of size can be performed to produce the book 80.

Step 208, judges whether or not the user may edit the book 80 manually. When the user wants to edit the book 80 manually, the user goes to step 209.

In step 209, the user uses the editing module 108 to preview, refine and modify the contents of the book 80. For example, the user may underline the important contents of the text part of the book 80, change the original texts to bold texts or make other similar changes. Alternatively, the user may insert additional illustrations or other related pictures or drawings.

To sum up, the system and method for producing books in accordance with the preferred embodiment of the invention can be used to analyze the video data 41. The video content analysis, character recognition, speech recognition technologies, and the like can be integrated for processing the audio data 411, caption data 412, and image data 413 of the video data 41 in this invention. Thereby, the video data can be efficiently used to produce book documents.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A book producing system for producing a book, which consists of a text part and an illustration part, comprising:
a video-receiving module for receiving video source data;
a decoding module for decoding the video source data to obtain video data;
a text-extracting module for extracting the text part from the video data according to a production guide;
an illustration-extracting module for extracting a key frame from the video data according to the production guide, the key frame serving as the illustration part; and
a book-producing module for producing the book according to the extracted text part and illustration part.

2. The book producing system according to claim 1, further comprising:
an editing module for receiving a command from a user to edit contents of the book after the book is produced.

3. The book producing system according to claim 1, further comprising:
a book-template-selecting module for receiving a selection from a user to provide at least one book template, the book-producing module producing the book by utilizing the book template.

4. The book producing system according to claim 1, further comprising:
a production-guide-selecting module for receiving a command from a user to select the production guide.

5. The book producing system according to claim 1, wherein the production guide comprises an audio-analyzing algorithm by which audio data in the video data are analyzed, the text-extracting module extracts the audio data to obtain the text part according to the audio-analyzing algorithm, and the illustration-extracting module extracts image data from the video data corresponding to the audio data as the illustration part.

6. The book producing system according to claim 1, wherein the production guide comprises a caption-analyzing algorithm by which caption data in the video data are analyzed, the text-extracting module extracts the caption data to obtain the text part according to the caption-analyzing algorithm, and the illustration-extracting module extracts image data from the video data corresponding to the caption data as the illustration part.

7. The book producing system according to claim 1, wherein the production guide comprises an image-analyzing algorithm by which image data in the video data are analyzed according to an image sample, the illustration-extracting module extracts the image data to obtain the illustration part according to the image-analyzing algorithm, and the text-extracting module extracts the text part from the video data corresponding to the image data.

8. The book producing system according to claim 1, wherein the production guide comprises an image-analyzing algorithm by which image data in the video data are analyzed according to an object, the illustration-extracting module extracts the image data to obtain the illustration part according to the image-analyzing algorithm, and the text-extracting module extracts the text part from the video data corresponding to the image data.

9. The book producing system according to claim 1, wherein the production guide comprises an image-analyzing algorithm by which image data in the video data are analyzed, the text-extracting module extracts captions in the image data as the text part, and the illustration-extracting module extracts the image data as the illustration part.

10. The book producing system according to claim 1, wherein the production guide comprises a scene/shot shift-analyzing algorithm by which scene/shot shifts of image data in the video data are analyzed, the text-extracting module and the illustration-extracting module use the scene/shot shift-analyzing algorithm as a selection and segmentation guide for the text part and the illustration part.

11. A book producing method for producing a book, which consists of a text part and an illustration part, comprising:
a video-receiving step for receiving video source data;
a decoding step for decoding the video source data to obtain video data;
a text-extracting step for extracting the text part from the video data according to a production guide;
an illustration-extracting step for extracting a key frame from the video data according to the production guide, the key frame serving as the illustration part; and
a book-producing step for producing the book according to the extracted text part and illustration part.

12. The book producing method according to claim 11, further comprising:
an editing step for receiving an operation from a user to edit contents of the book after the book is produced.

13. The book producing method according to claim 11, further comprising:
a book-template-selecting step for receiving a command from a user to select at least one book template, the book-producing step producing the book by utilizing the book template.

14. The book producing method according to claim 11, further comprising:
a production-guide-selecting step for receiving a selection from a user to provide the production guide.

15. The book producing method according to claim 11, wherein the production guide comprises an audio-analyzing algorithm by which audio data in the video data are analyzed, the text-extracting step is performed for extracting the audio data to obtain the text part according to the audio-analyzing algorithm, and the illustration-extracting step is performed for extracting image data from the video data corresponding to the audio data as the illustration part.

16. The book producing method according to claim 11, wherein the production guide comprises a caption-analyzing algorithm by which caption data in the video data are analyzed, the text-extracting step is performed for extracting the caption data to obtain the text part according to the caption-analyzing algorithm, and the illustration-extracting step is performed for extracting image data from the video data corresponding to the caption data as the illustration part.

17. The book producing method according to claim 11, wherein the production guide comprises an image-analyzing algorithm by which image data in the video data are analyzed according to an image sample, the illustration-extracting step is performed for extracting the image data to obtain the illustration part according to the image-analyzing algorithm, and the text-extracting step is performed for extracting the text part from the video data corresponding to the image data.

18. The book producing method according to claim 11, wherein the production guide comprises an image-analyzing algorithm by which image data in the video data are analyzed according to an object, the illustration-extracting step is performed for extracting the image data to obtain the illustration part according to the image-analyzing algorithm, and the text-extracting step is performed for extracting the text part from the video data corresponding to the image data.

19. The book producing method according to claim 11, wherein the production guide comprises an image-analyzing algorithm by which image data in the video data are analyzed, the text-extracting step is performed for extracting captions in the image data as the text part, and the illustration-extracting step is performed for extracting the image data as the illustration part.

20. The book producing method according to claim 11, wherein the production guide comprises a scene/shot shift-analyzing algorithm by which scene/shot shifts of image data in the video data are analyzed, the text-extracting step and the illustration-extracting step are performed using the scene/shot shift-analyzing algorithm as a selection and segmentation guide for the text part and the illustration part.

21. A recording medium on which is recorded a program to enable a computer to perform a book producing method, the book producing method comprising:
a video-receiving step for receiving video source data;
a decoding step for decoding the video source data to obtain video data;
a text-extracting step for extracting the text part from the video data according to a production guide;
an illustration-extracting step for extracting a key frame from the video data according to the production guide, the key frame serving as the illustration part; and
a book-producing step for producing the book according to the extracted text part and illustration part.

22. The recording medium according to claim 21, wherein the book producing method further comprises:
an editing step for receiving an operation from a user to edit contents of the book after the book is produced.

23. The recording medium according to claim 21, wherein the book producing method further comprises:
a book-template-selecting step for receiving a command from a user to select at least one book template, the book-producing step producing the book by utilizing the book template.

24. The recording medium according to claim 21, wherein the book producing method further comprises:
a production-guide-selecting step for receiving a command from a user to select the production guide.

25. The recording medium according to claim 21, wherein the production guide comprises an audio-analyzing algorithm by which audio data in the video data are analyzed, the text-extracting step is performed for extracting the audio data to obtain the text part according to the audio-analyzing algorithm, and the illustration-extracting step is performed for extracting image data from the video data corresponding to the audio data as the illustration part.

26. The recording medium according to claim 21, wherein the production guide comprises a caption-analyzing algorithm by which caption data in the video data are analyzed, the text-extracting step is performed for extracting the caption data to obtain the text part according to the caption-analyzing algorithm, and the illustration-extracting step is performed for extracting image data from the video data corresponding to the caption data as the illustration part.

27. The recording medium according to claim 21, wherein the production guide comprises an image-analyzing algorithm by which image data in the video data are analyzed according to an image sample, the illustration-extracting step is performed for extracting the image data to obtain the illustration part according to the image-analyzing algorithm, and the text-extracting step is performed for extracting the text part from the video data corresponding to the image data.

28. The recording medium according to claim 21, wherein the production guide comprises an image-analyzing algorithm by which image data in the video data are analyzed according to an object, the illustration-extracting step is performed for extracting the image data to obtain the illustration part according to the image-analyzing algorithm, and the text-extracting step is performed for extracting the text part from the video data corresponding to the image data.

29. The recording medium according to claim 21, wherein the production guide comprises an image-analyzing algorithm by which image data in the video data are analyzed, the text-extracting step is performed for extracting captions in the image data as the text part, and the illustration-extracting step is performed for extracting the image data as the illustration part.

30. The recording medium according to claim 21, wherein the production guide comprises a scene/shot shift-analyzing algorithm by which scene/shot shifts of image data in the video data are analyzed, the text-extracting step and the illustration-extracting step are performed using the scene/shot shift-analyzing algorithm as a selection and segmentation guide for the text part and the illustration part.
